(19) United States
(12) Patent Application Publication
(10) Pub. No.: US 2026/0016604 A1
(43) Pub. Date: Jan. 15, 2026

(54) RANGING APPARATUS AND RANGING METHOD

(71) Applicant: JVCKENWOOD Corporation, Yokohama-shi (JP)

(72) Inventor: Toshihide KOBAYASHI, Yokohama-shi (JP)

(21) Appl. No.: 19/333,993

(22) Filed: Sep. 19, 2025

Related U.S. Application Data
(63) Continuation of application No. PCT/JP2024/004011, filed on Feb. 7, 2024.

(30) Foreign Application Priority Data
Mar. 24, 2023 (JP) 2023-047751

(51) Int. Cl. G01S 17/89; G01S 7/481; G06T 7/215; G06T 7/246; G06T 7/521; G06T 7/579

(52) U.S. Cl. CPC G01S 17/89; G01S 7/4815; G06T 7/215; G06T 7/248; G06T 7/521; G06T 7/579; G06T 2207/10028; G06T 2207/10152

(57) ABSTRACT

A ranging apparatus includes: a first light source that irradiates a subject; a second light source that irradiates the subject; a distance sensor that detects a light from the subject and generates a distance image; a light source control unit that switches between a normal pattern of lighting the first light source and the second light source, a first evaluation pattern of lighting the first light source, and a second evaluation pattern of lighting the second light source; a correlator that calculates a correlation value between a first evaluation distance image generated at a time of irradiation with the first evaluation pattern and a second evaluation distance image generated at a time of irradiation with the second evaluation pattern; and a smoothing processing unit that generates a corrected distance image by applying a smoothing process of an intensity determined by the correlation value to a normal distance image.

### CROSS-REFERENCE TO RELATED APPLICATION

This application is a continuation of application No. PCT/JP2024/004011, and claims the benefit of priority from the prior Japanese Patent Application No. 2023-47751, filed on Mar. 24, 2023, the entire contents of which is incorporated herein by reference.

### BACKGROUND

### 1. Field of the Invention

The present disclosure relates to a ranging apparatus and a ranging method.

### 2. Description of the Related Art

A ranging apparatus is known that is adapted to irradiate a subject with a highly directional illumination light such as laser light and generate a distance image by detecting a reflected light from the subject by using a distance sensor such as a ToF (Time of Flight) sensor. However, such an illumination light has coherence and so may produce a speckle noise in the distance image. Several technologies directed to reduction of speckle noise have been proposed. For example, patent literature 1 discloses a technology that reduces the contrast of speckle to 1/√N by combining multiple (N) light projection means arranged such that the optical paths as far as the object surface differ and by adding up multiple laser beams projected from the multiple light projection means. Further, patent literature 2 discloses a technology of reducing noise by changing the phase of scattered light by modulating the oscillation wavelength of the laser light and by superimposing changed speckle patterns.
[Patent literature 1] JPH5-141965
[Patent literature 2] JP2020-9749

### SUMMARY

The technology disclosed in patent literature 1 requires a large number of lighting means to reduce speckle noise sufficiently. The technology disclosed in patent literature 2 requires preparing an apparatus capable of modulating the oscillation wavelength to emit laser light of multiple wavelengths.

A ranging apparatus according to an embodiment of the present disclosure includes: a first light source that irradiates a subject with a first illumination light; a second light source that irradiates the subject with a second illumination light; a distance sensor that detects a light from the subject and generates a distance image; a light source control unit that switches between a normal pattern of lighting the first light source and the second light source, a first evaluation pattern of lighting the first light source, and a second evaluation pattern of lighting the second light source; a correlator that calculates, for each of a plurality of evaluation regions set in the distance image, a correlation value between a first evaluation distance image generated at a time of irradiation with the first evaluation pattern and a second evaluation distance image generated at a time of irradiation with the second evaluation pattern; and a smoothing processing unit that generates a corrected distance image by applying a smoothing process of an intensity determined by the correlation value to a normal distance image generated at a time of irradiation with the normal pattern.

Another embodiment of the present disclosure relates to a ranging method. The method comprising: switching between a normal pattern of lighting a first light source that irradiates a subject with a first illumination light and a second light source that irradiates the subject with a second illumination light, a first evaluation pattern of lighting the first light source, and a second evaluation pattern of lighting the second light source; detecting a light from the subject by using a distance sensor and generating a distance image; calculating, for each of a plurality of evaluation regions set in the distance image, a correlation value between a first evaluation distance image generated at a time of irradiation with the first evaluation pattern and a second evaluation distance image generated at a time of irradiation with the second evaluation pattern; and generating a corrected distance image by applying a smoothing process of an intensity determined by the correlation value to a normal distance image generated at a time of irradiation with the normal pattern.

Optional combinations of the aforementioned constituting elements, and mutual substitution of constituting elements and implementations of the present disclosure between methods, apparatuses, systems, etc. may also be practiced as additional modes of the present disclosure.

### BRIEF DESCRIPTION OF THE DRAWING

Embodiments will now be described, by way of example only, with reference to the accompanying drawings which are meant to be exemplary, not limiting, and wherein like elements are numbered alike in several Figures, in which:

FIG. 1 shows an example of an image capturing a subject;

FIGS. 2A and 2B show exemplary point cloud images of the subject identical to that of FIG. 1;

FIG. 3 schematically shows a configuration of a ranging apparatus according to the first embodiment;

FIG. 4 is a schematic diagram showing a configuration of the light source apparatus of FIG. 3;

FIG. 5 is a block diagram schematically showing a functional configuration of the distance image correction unit of FIG. 3;

FIG. 6 is a conceptual diagram showing an exemplary setting of multiple evaluation regions;

FIG. 7 is a conceptual diagram showing exemplary multiple evaluation regions overlapping horizontally;

FIG. 8 is a conceptual diagram showing exemplary multiple evaluation regions overlapping vertically;

FIG. 9A-9C show exemplary evaluation regions used to calculate the inclination component value by the inclination calculation unit;

FIG. 10 is a conceptual diagram showing an exemplary flow of the smoothing process;

FIG. 11 shows exemplary coefficients of the low-pass filter used for the smoothing process;

FIG. 12 shows a distance image, a point cloud image, and a difference value image according to the first exemplary embodiment;

FIG. 13 shows a distance image, a point cloud image, and a difference value image according to the second exemplary embodiment;

FIG. 14 is a flow chart showing a process of calculating the index value according to the first embodiment;

FIG. 15 is a flowchart showing a process of correcting the normal distance image according to the first embodiment;

FIG. 16 schematically shows a configuration of a ranging apparatus according to the second embodiment;

FIG. 17 is a schematic diagram showing a configuration of the light source apparatus of FIG. 17;

FIG. 18 is a block diagram schematically showing a functional configuration of the distance image correction unit of FIG. 17; and

FIG. 19 shows an exemplary operation of the distance image correction unit of FIG. 17 in units of frames.

### DETAILED DESCRIPTION

The invention will now be described by reference to the preferred embodiments. This does not intend to limit the scope of the present invention, but to exemplify the invention.

A description will be given below of embodiments of the present disclosure with reference to the drawings. Specific numerical values shown in the embodiments are by way of example only to facilitate the understanding of the invention and should not be construed as limiting the disclosure unless specifically indicated as such. Those elements in the drawings not directly relevant to the present disclosure are omitted from the illustration.

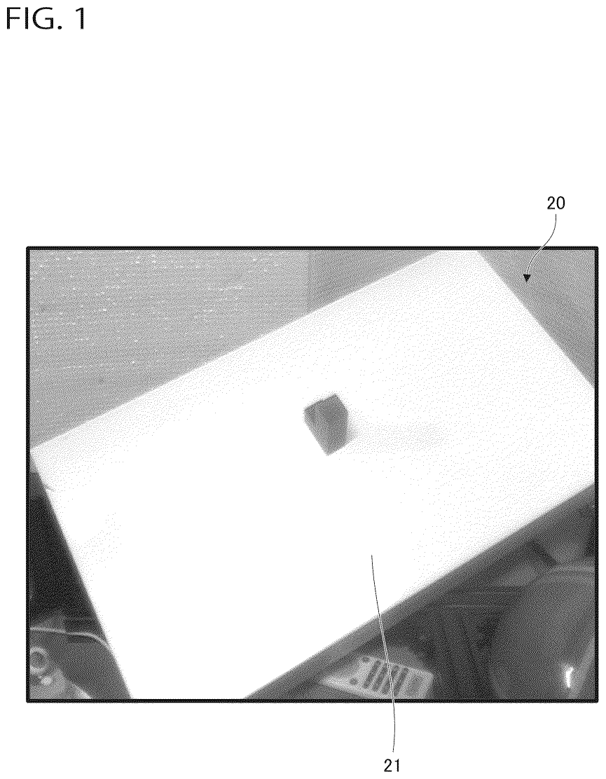

First, before going into the description of the embodiment, a brief description will be given of speckle noise in a distance image. FIG. 1 shows an example of an image capturing a subject 20, which is taken with a common camera. The subject 20 has a surface 21 comprised of a smooth plane with few uneven shapes. As shown in FIG. 1, the surface 21 of the subject 20 appears to be a smooth plane with few uneven shapes according to the captured image.

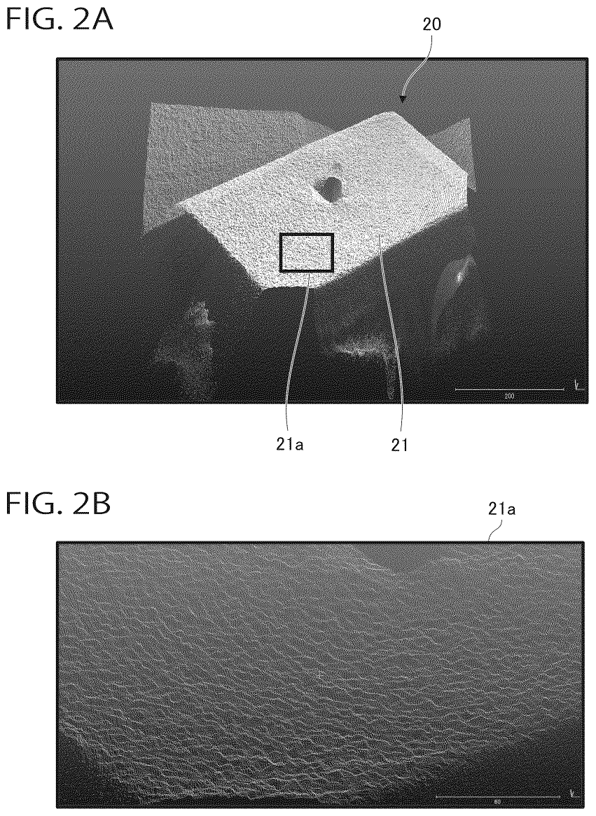

FIGS. 2A and 2B show exemplary point cloud images of the subject 20 identical to that of FIG. 1. Specifically, FIG. 2A shows point cloud data derived from converting a distance image of the subject 20 generated by using VCSEL (Vertical Cavity Surface Emitting Laser), which emits a laser light as an illumination light, as a light source and by using a TOF sensor. FIG. 2B is a point cloud image showing a rectangular region 21a, which is part of the surface 21 of the subject 20 shown in FIG. 2A, on an enlarged scale. As shown in FIGS. 2A and 2B, the surface 21 of the subject 20, which appears to be a smooth plane in the captured image of FIG. 1, appears to include a wavy uneven shape in the point cloud image. This is due to the coherence of laser light, which causes the reflected light from the subject 20 to form interference fringes, resulting in the speckle noise appearing in the distance image. The uneven shape caused by the speckle noise poses a problem because it does not represent the actual shape on the surface 21 of the subject 20. Since the magnitude of the speckle noise is relatively small, the speckle noise is not so noticeable when the surface 21 of the subject 20 actually includes an uneven shape. When the surface 21 of the subject 20 is a smooth plane, on the other hand, the speckle noise is particularly noticeable.

We have found the following scheme to make the speckle noise in a distance image less noticeable. First, multiple evaluation distance images are obtained by irradiating the subject 20 with a illumination light at different points of time from multiple light sources arranged at mutually different positions. It is considered that the speckle noise generated in the multiple evaluation distance images differ from each other due to the difference in the angle of illumination light of the multiple light sources. On the other hand, the uneven shape on the surface of the subject included in the multiple evaluation distance images are considered to be common among the images because they represent the same subject. It is considered that, when a correlation value is calculated by comparing the multiple evaluation distance images region by region, the correlation value will be high if the uneven shape of the subject is dominant, and the correlation value will be low when the speckle noise is dominant. Based on these correlation values, the intensity of the smoothing process to make the speckle noise less noticeable is adjusted. Specifically, the smoothing process is intensified in a region with a low correlation value, and the smoothing process is weakened in a region with a high correlation value. This makes it possible to intensify the smoothing process to make the speckle noise less noticeable in a region where the speckle noise is dominant. Meanwhile, it is possible to weaken the smoothing process to make the uneven shape of the subject less likely to be lost in a region where the speckle noise is not dominant. As a result, it is possible to reduce the noticeable speckle noise effectively, while maintaining the reproducibility of the uneven shape on the subject surface in the distance image as a whole. The embodiment will be described in the following.

### First Embodiment

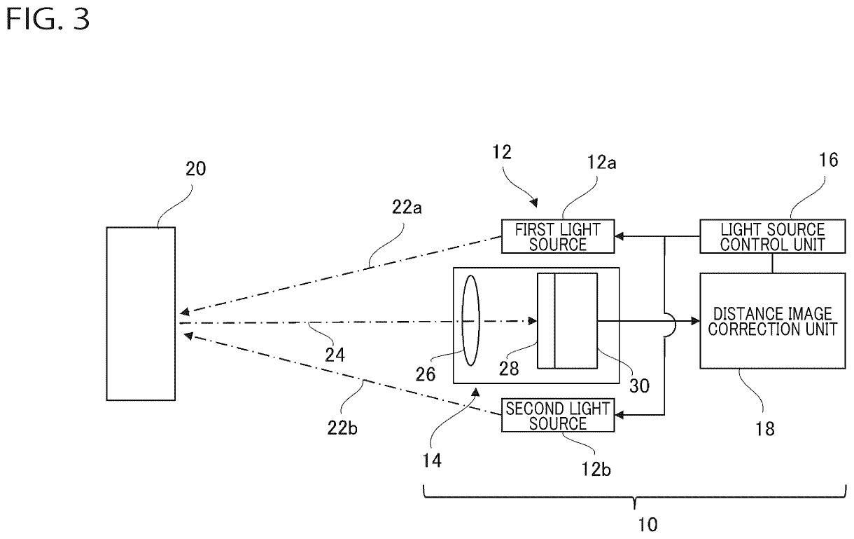

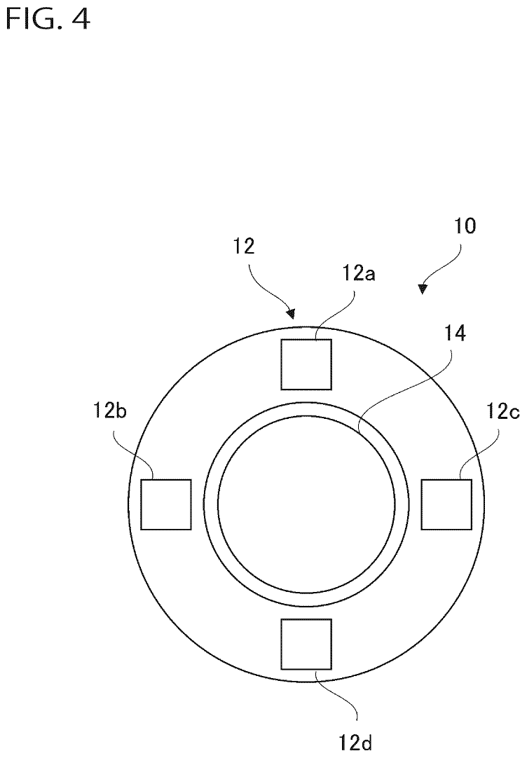

FIG. 3 schematically shows a configuration of a ranging apparatus 10 according to the first embodiment. The ranging apparatus 10 is equipped with a light source apparatus 12, a distance sensor block 14, a light source control unit 16, and a distance image correction unit 18. The light source apparatus 12 has, for example, a first light source 12a and a second light source 12b. The light source apparatus 12 is additionally equipped with a third light source 12c and a fourth light source 12d as shown in FIG. 4 discussed below.

FIG. 4 is a schematic diagram showing a configuration of the light source apparatus 12. FIG. 4 shows the ranging apparatus 10 viewed from the side of the subject 20. The light source apparatus 12 is equipped with a first light source 12a, a second light source 12b, a third light source 12c, and a fourth light source 12d. The first light source 12a-the fourth light source 12d each emits a coherent illumination light such as a laser light. Each of the first light source 12a-the fourth light source 12d is comprised of a light-emitting apparatus such as VCSEL. The first light source 12a irradiates the subject 20 with a first illumination light 22a (see FIG. 3). The second light source 12b irradiates the subject 20 with a second illumination light 22b (see FIG. 3). The third light source 12c irradiates the subject 20 with a third illumination light. The fourth light source 12d irradiates the subject 20 with a fourth illumination light. The first light source 12a-the fourth light source 12d are arranged at different positions, and the angles at which the first illumination light 22a-the fourth illumination light irradiate the subject 20 are also different. The first illumination light 22a-the fourth illumination light can be visible light or infrared light. In this example, the first illumination light 22a-the fourth illumination light are assumed to be infrared light with a peak wavelength of 940 nm. Hereinafter, each illumination light emitted by the light source apparatus 12 onto the subject 20 will collectively be referred to as an illumination light 22.

In the example of FIG. 4, the first light source 12a-the fourth light source 12d are arranged at roughly equal intervals so as to surround a lens 26 described below, which is provided in the distance sensor block 14. For example, the first light source 12a-the fourth light source 12d are arranged above, below, to the left of, and to the right of the distance sensor block 14, respectively. Specifically, the first light source 12a and the fourth light source 12d are arranged above and below the distance sensor block 14, and the second light source 12b and the third light source 12c are arranged to the left of and to the right of the distance sensor block 14. For example, the first light source 12a-the fourth light source 12d are arranged such that the illumination light 22 of the light source apparatus 12 as a whole is symmetrical with respect to the optical axis of the lens 26 when all of the first light source 12a-the fourth light source 12d are turned on. The number of multiple light sources provided in the light source apparatus 12 is not limited to four, but two or more light sources may be provided.

Referring back to FIG. 3, the distance sensor block 14 is comprised of a distance sensor such as a ToF sensor. The ranging scheme of the ToF sensor may be iToF (indirect time of flight) or dToF (direct time of flight). The distance sensor block 14 detects a light 24 from the subject 20 and generates a distance image. The light 24 from the subject 20 is, for example, the illumination light 22 from the light source apparatus 12 reflected by the subject 20. The light 24 from the subject 20 also includes scattered light. The distance sensor block 14 is equipped with a lens 26, an imaging element 28, and a distance conversion unit 30.

The lens 26 is provided in front of the imaging element 28 (on the side where the subject 20 is located). The lens 26 is arranged to cause the light 24 from the subject 20 incident on the distance sensor block 14 to be imaged on the light-receiving surface of the imaging element 28. The lens 26 may include one or more optical lenses.

The imaging element 28 is comprised of, for example, a two-dimensional image sensor such as a CCD (Charge Coupled Devices) sensor or a CMOS (Complementary Metal Oxide Semiconductor) sensor. The imaging element 28 has multiple pixels in the horizontal and vertical directions, respectively. The number of pixels of the imaging element 28 is not particularly limited. For example, the imaging element 28 has 640 pixels in width×480 pixels in height. The imaging element 28 subjects the light imaged on the light-receiving surface to photoelectric conversion pixel by pixel and outputs a resultant electrical signal to the distance conversion unit 30. The imaging element 28 outputs an electrical signal for each pixel at, for example, 20 frames per second, which is a non-limiting feature.

The distance conversion unit 30 converts the electrical signal for each pixel input from the imaging element 28 into a distance value indicating the distance to the subject. The distance sensor block 14 outputs, as a distance image, the distance value of each of the pixels derived from conversion by the distance conversion unit 30 to the distance image correction unit 18. The distance sensor block 14 may output, as a serial signal, the distance value of each pixel derived from conversion by the distance conversion unit 30 to the distance image correction unit 18 or may output distance image data aggregating the distance values for all pixels to the distance image correction unit 18.

The light source control unit 16 switches the lighting pattern of the first light source 12a-the fourth light source 12d. Specifically, the light source control unit 16 switches between a normal pattern of lighting all of the first light source 12a-the fourth light source 12d and an evaluation pattern of lighting some of the first light source 12a-the fourth light source 12d. The evaluation pattern includes the first evaluation pattern of lighting the first light source 12a, the second evaluation pattern of lighting the second light source 12b, the third evaluation pattern of lighting the third light source 12c, and the fourth evaluation pattern of lighting the fourth light source 12d. Hereinafter, the distance image generated by the distance sensor block 14 at the time of irradiation with the normal pattern will be referred to as a normal distance image. Further, the image generated by the distance sensor block 14 at the time of irradiation with the mth evaluation pattern will be referred to as the mth evaluation distance image. m denotes a positive integer. The evaluation distance image is used to evaluate the influence of speckle noise included in normal distance image. The influence rate of speckle noise is evaluated based on a correlation value between multiple evaluation distance images. By applying a smoothing process of an intensity determined by the calculated correlation value to the normal distance image, a corrected distance image corrected such that the speckle noise is not noticeable is generated. Details on calculation of the correlation value and generation of the corrected distance image will be described below.

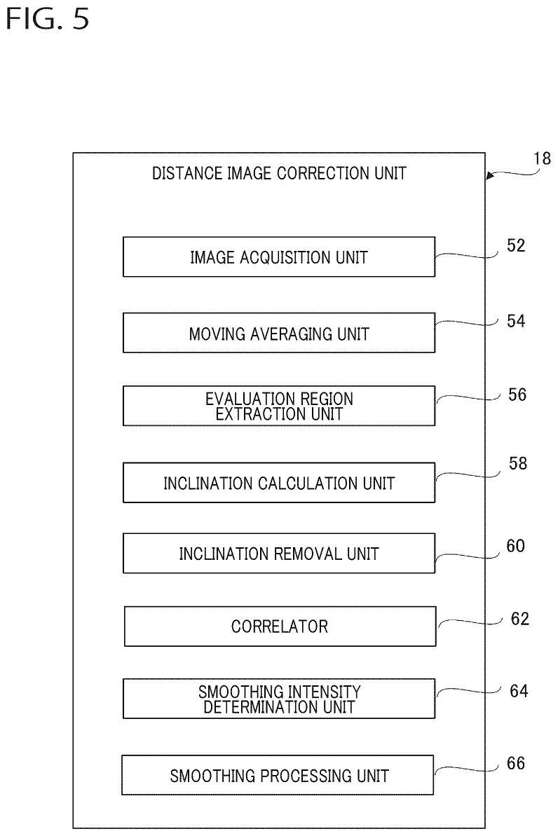

FIG. 5 is a block diagram schematically showing a functional configuration of the distance image correction unit 18. The distance image correction unit 18 is equipped with an image acquisition unit 52, a moving averaging unit 54, an evaluation region extraction unit 56, an inclination calculation unit 58, an inclination removal unit 60, a correlator 62, a smoothing intensity determination unit 64, and a smoothing processing unit 66.

The functional blocks presented in this embodiment are implemented by coordination of hardware and software. The hardware of the distance image correction unit 18 is implemented by devices and mechanical apparatus exemplified by a processor such as a CPU (Central Processing Unit) and a GPU (Graphics Processing Unit) of a computer and by a memory such as a ROM (Read Only Memory) and a RAM (Random Access Memory) of a computer. The software of the distance image correction unit 18 is implemented by a computer program, etc.

The image acquisition unit 52 acquires the distance image generated by the distance sensor block 14. The image acquisition unit 52 acquires the normal distance image, the first evaluation distance image, the second evaluation distance image, the third evaluation distance image, and the fourth evaluation distance image. For each of the normal distance image, the first evaluation distance image, the second evaluation distance image, the third evaluation distance image, and the fourth evaluation distance image, the image acquisition unit 52 may acquire a distance image comprised of multiple frames generated at different points of time.

The moving averaging unit 54 derives a moving average of the pixel values of the distance image comprised of multiple frames acquired by the image acquisition unit 52 in the temporal direction. The moving average in this case may be a simple moving average or a weighted moving average. The moving averaging unit 54 can reduce random noise other than speckle noise in the distance image by calculating the moving average of the pixel values of multiple frames of the distance image. By applying the process of the moving averaging unit 54 to the evaluation distance image, the influence of random noise on the calculated correlation value can be reduced in calculating the correlation value between multiple evaluation distance images.

The evaluation region extraction unit 56 extracts multiple evaluation regions comprised of predetermined multiple pixels from the distance image acquired by the image acquisition unit 52 or the distance image subjected to moving averaging by the moving averaging unit 54. The evaluation region may be a preset region. Multiple evaluation regions may be set so as to overlap partially. The size of the evaluation region can be set as desired according to the magnitude of speckle noise to be reduced. The evaluation region is a region comprised of, for example, 64 pixels in width×64 pixels in height.

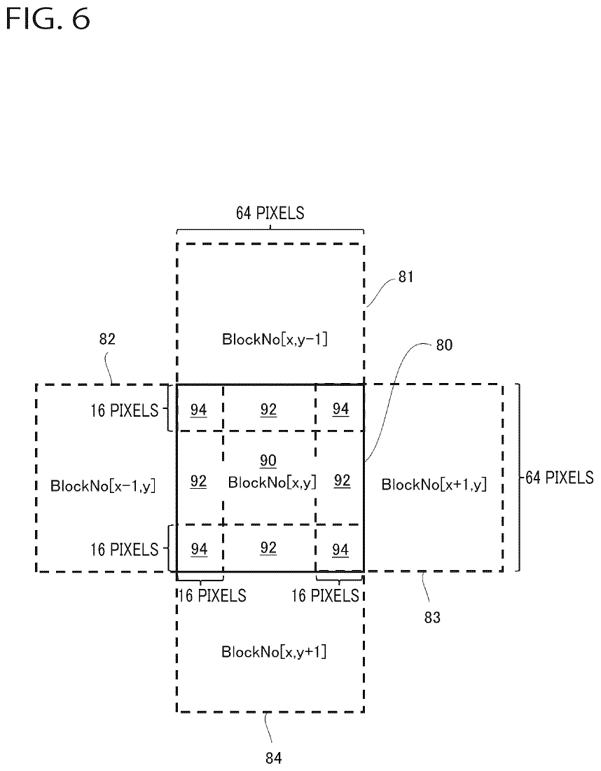

FIG. 6 is a conceptual diagram showing an exemplary setting of multiple evaluation regions. FIG. 6 shows an evaluation region 80 set at a desired position other than the periphery of the distance image and four evaluation regions 81, 82, 83, 84 overlapping the evaluation region 80 above, below, to the left, and to the right. BlockNo[x,y] in FIG. 6 denotes horizontal and longitudinal region numbers of the evaluation region. Denoting the evaluation region 80 at the center of FIG. 6 as BlockNo[x,y], the upper evaluation region 81 is denoted by BlockNo[x,y−1], the lower evaluation region 84 is denoted by BlockNo[x,y+1], the left evaluation region 82 is denoted by BlockNo[x−1,y], and the right evaluation region 83 is denoted by BlockNo[x+1,y].

As shown in FIG. 6, the central evaluation region 80 (BlockNo[x,y]) has a non-overlapping region 90 that does not overlap the evaluation regions 81-84 located above, below, to the left, and to the right, and a first overlapping region 92 and a second overlapping region 94 overlapping at least one of the evaluation regions 81-84 located above, below, to the left, and to the right. The first overlapping region 92 is a region where two evaluation regions overlap, and the second overlapping region 94 is a region where three or more evaluation regions overlap. Each evaluation region shown in FIG. 6 is comprised of 64 pixels in width×64 pixels in height. Further, the central evaluation region 80 (BlockNo[x,y]) overlaps each of the four evaluation regions 81-84 located above, below, to the left, and to the right by 16 pixels in at least one of the horizontal direction or the vertical direction.

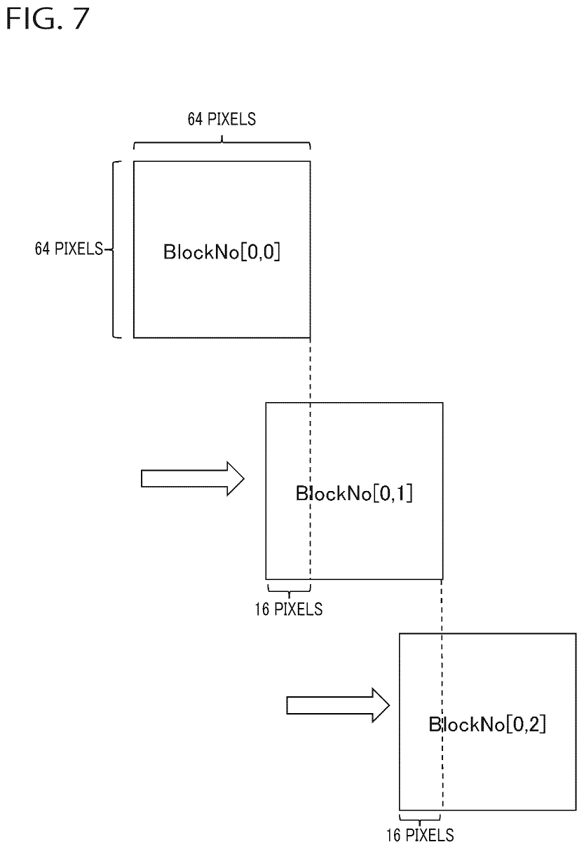

FIG. 7 is a conceptual diagram showing exemplary multiple evaluation regions overlapping horizontally. Of the multiple evaluation regions set in the distance image, the evaluation region located in the upper left corner will be denoted by BlockNo[0,0], and the evaluation regions located on the right side in the horizontal direction will be sequentially denoted by BlockNo[0,1], BlockNo[0,2] . . . . Each evaluation region is a region comprised of 64 pixels in width×64 pixels in height, and the evaluation regions arranged in succession in the horizontal direction overlap each other by 16 pixels horizontally. In other words, of the total of 64×64=4096 pixels in each evaluation region, the overlapping region between BlockNo[0,0] and BlockNo[0,1] and the overlapping region between BlockNo[0,1] and BlockNo[0,2] are both comprised of 16×64=1024 pixels.

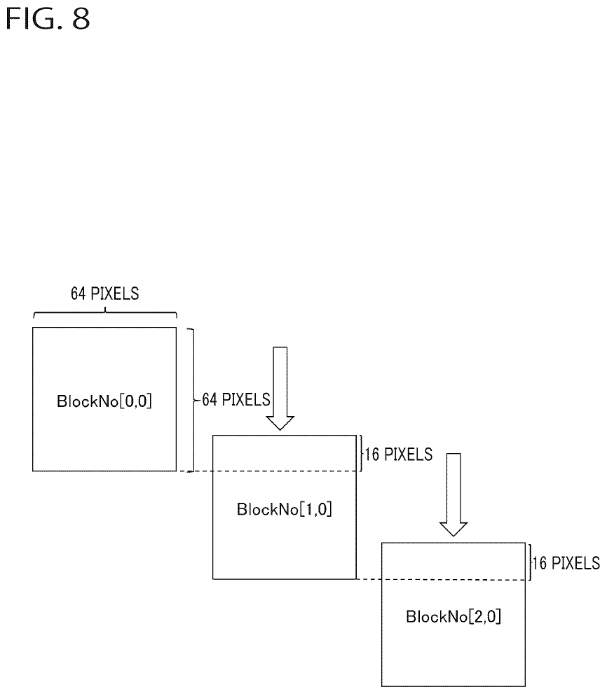

FIG. 8 is a conceptual diagram showing exemplary multiple evaluation regions overlapping vertically. Of the multiple evaluation regions set in the distance image, the evaluation region located in the upper left corner will be denoted by BlockNo[0,0], and the evaluation regions located below in the vertical direction will be sequentially denoted by BlockNo[0,1], BlockNo[0,2], . . . . Each evaluation region is a region comprised of 64 pixels in width×64 pixels in height, and the evaluation regions arranged in succession in the vertical direction overlap each other by 16 pixels horizontally. In other words, of the total of 64×64=4096 pixels in each evaluation region, the overlapping region between BlockNo[0,0] and BlockNo[0,1] and the overlapping region between BlockNo[0,1] and BlockNo[0,2] are both comprised of 16×64=1024 pixels.

Referring back to FIG. 5, the inclination calculation unit 58 refers to the evaluation distance image in which multiple evaluation regions are set and calculates an inclination component value of each pixel based on the average value of the pixel values of multiple pixels arranged vertically or horizontally in each region of the multiple evaluation regions. The inclination component value means the inclination of the surface 21 of the subject 20 in the depth direction and refers to a distance value averaged to exclude a small uneven shape on the surface 21 of the subject 20. For example, the inclination calculation unit 58 may refer to the average value of the pixel values of multiple pixels arranged in the vertical direction and that of the horizontal direction in each region of the multiple evaluation regions and determines the average value, for which the absolute value of the difference from the average value of the pixel values in the entirety of each evaluation region is larger, to be inclination component value of each pixel.

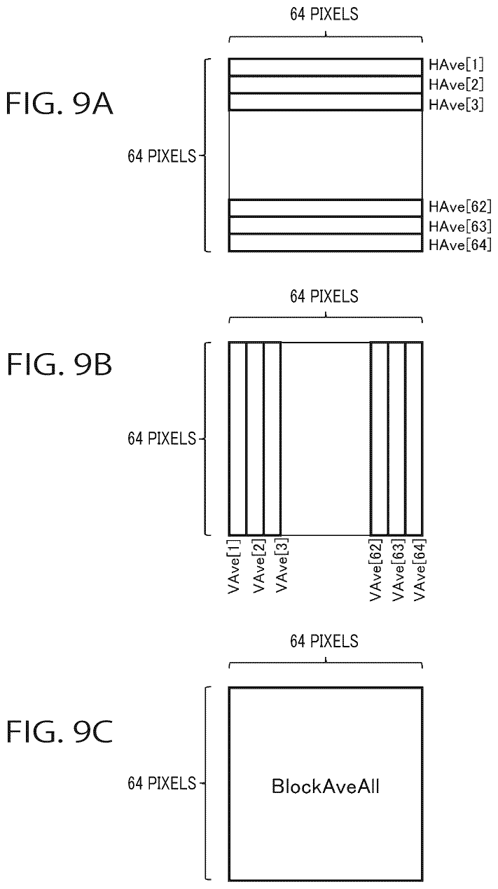

FIG. 9A-9C show exemplary evaluation regions used to calculate the inclination component value by the inclination calculation unit 58. In the example of FIG. 9A-9C, the evaluation region is a region comprised of 64 pixels in width×64 pixels in height. FIG. 9A shows horizontal average values, each of which is the average of the pixel values of multiple pixels arranged horizontally within the evaluation region. As shown in FIG. 9A, 64 horizontal average values HAve[1], HAve[2], HAve[3], . . . , HAve[62], HAve[63], and HAve[64] are calculated. FIG. 9B shows vertical average values, each of which is the average of the pixel values of multiple pixels arranged vertically within the evaluation region. As shown in FIG. 9(b), 64 vertical average values VAve[1], VAve[2], VAve[3], . . . , VAve[62], VAve[63], and VAve[64] are calculated. FIG. 9C shows an overall average value BlockAveAll, which is the average value of the pixel values in the entire evaluation region.

For example, the inclination calculation unit 58 calculates the inclination component value HV_Ave[L] of a pixel with a vertical pixel number L, by using the following expression (1).

```
IF (ABS( HAve[L]−BlockAveAll)>ABS(VAve[L]−BlockAveAll))
  HV_Ave[L]=HAve[L]
ELSE
  HV_Ave[L]=VAve[L] ... (1)
```

where ABS denotes the absolute value, and HV_Ave[L] denotes the inclination component value of the pixel with the vertical pixel number L. By calculating expression (1) for L=1 to 64, i.e., for all pixels in the evaluation region, the inclination component value of all pixels in the evaluation region can be calculated. In this example, the multiple pixels arranged horizontally are assumed to have the same inclination component value. By configuring the inclination component values of the multiple pixels arranged horizontally to be identical, the overall inclination component in the evaluation region can be properly represented. According to our findings, the difference in the inclination component value between adjacent pixels may be large and the overall inclination component cannot be properly represented, if the inclination component value is calculated for each pixel individually. In an alternative to this example, the multiple pixels arranged vertically, instead of horizontally, may be configured to have the same inclination component value. For example, the vertical pixel number L in expression (1) may be replaced by the horizontal pixel number P to calculate the inclination component value of the pixel with the horizontal pixel number P. In this case, the overall inclination component in the evaluation region can be properly represented by configuring the inclination component values of the multiple pixels arranged vertically to be identical.

Referring back to FIG. 5, the inclination removal unit 60 calculates a difference value by subtracting the inclination component value from the pixel value of each pixel in the evaluation distance image. The difference value corresponds to removal of the overall inclination of the surface 21 of the subject 20 in the depth direction from the distance value indicating the position of the surface 21 of the subject 20. The difference value corresponds to a sum of the component of an uneven shape on the surface 21 of the subject 20 and the component of speckle noise visible on the surface 21.

The inclination removal unit 60 may also clip the difference value with the upper and lower values. The inclination removal unit 60 can reduce the influence of outliers such as flying pixels from the difference value by clipping the difference value with the upper and lower values. Since the component of speckle noise included in the difference value is relatively small, outliers that are significantly larger than the magnitude of the speckle noise can be excluded by clipping the difference value with the upper and lower values.

For example, the inclination removal unit 60 calculates the difference value DIFF[P,L] for the pixel value DEPTH[P,L] of a pixel with the horizontal pixel number P and the vertical pixel number L, by using the inclination component value HV_Ave[L] calculated by expression (1) and using expression (2) below.

```
IF DEPTH[P,L]−HV_Ave[L]<=−CLIPLEV
  DIFF[P,L]=−CLIPLEV
ELSE IF DEPTH[P,L]−HV_Ave[L]>=CLIPLEV
  DIFF[P,L]=CLIPLEV
ELSE
  DIFF[P,L] = DEPTH[P,L]−HV_Ave[L] ... (2)
```

where CLIPLEV denotes the upper limit value of the difference value, and −CLIPLEV denotes the lower limit value of the difference value. The magnitude of CLIPLEV may be set according to the maximum value of speckle noise predicted.

For example, the inclination removal unit 60 uses expression (2) to calculate the difference value (DIFF1[P,L], DIFF2[P,L], DIFF3[P,L], and DIFF4[P,L]) clipped by the upper and lower values, for the pixel value (DEPTH1[P,L], DEPTH2[P,L], DEPTH3[P,L] and DEPTH4[P,L]) of each pixel in the evaluation region of each of the first evaluation distance image, the second evaluation distance image, the third evaluation distance image, and the fourth evaluation distance image.

The correlator 62 calculates, for each evaluation region, a correlation value between two desired evaluation distance images of the multiple evaluation distance images. The correlator 62 may calculate the correlation value by using the difference value calculated by the inclination removal unit 60. In other words, the correlator 62 may calculate the correlation value by using the difference value derived from subtracting the inclination component value from the pixel value of each pixel in the first evaluation distance image and the second evaluation distance image. Alternatively, the correlator 62 may, when the difference value is greater than a predetermined upper limit value, use the upper limit value to calculate the correlation value and may, when the difference value is smaller than a predetermined lower limit value, use the lower limit value to calculate the correlation value.

For example, the correlator 62 uses expression (3) below to calculate the correlation value (r) for each evaluation region.

$$r = \frac{\frac{1}{n} {\sum }_{i = 1}^{n} ( {x}_{i} - x\_ave ) ( {y}_{i} - y\_ave )}{\sqrt{\frac{1}{n} {\sum }_{i = 1}^{n} {( {x}_{i} - x\_ave )}^{2}} \sqrt{\frac{1}{n} {\sum }_{i = 1}^{n} {( {y}_{i} - y\_ave )}^{2}}} \qquad ( 3 )$$

where n denotes the number of pixels in the evaluation region. When the evaluation region is a region comprised of 64 pixels in width×64 pixels in height, for example, n=64×64=4096. xi denotes the difference value (DIFFx) for each pixel in the evaluation region of one of the two evaluation distance images used to calculate the correlation value. x_ave denotes the average value of the difference values of all pixels in the evaluation region of the one evaluation distance image. yi denotes the difference value (DIFFy) for each pixel in the evaluation region of the other evaluation distance image. y_ave denotes the average value of the difference values of all pixels in the evaluation region of the other evaluation distance image.

For example, the correlator 62 substitutes, when calculating the first correlation value between the first evaluation distance image and the second evaluation distance image for each evaluation region, DIFF1(P,L) for DIFFx and substitutes DIFF2(P,L) for DIFFy such that P=1 to 64, L=1 to 64. The first correlation value indicates the correlation (or similarity), in the evaluation region, between the difference value of the first evaluation distance image and that of the second evaluation distance image. As mentioned above, the difference value includes the component of an uneven shape on the surface 21 of the subject 20 and the speckle noise component. The component of an uneven shape is relatively less influenced by a difference in illumination light and so produces a relatively small difference between the first evaluation distance image and the second evaluation distance image. On the other hand, the speckle noise component is relatively more influenced by a difference in illumination light and so produces a relatively large difference between the first evaluation distance image and the second evaluation distance image. Therefore, a large correlation value means that the influence of speckle noise is small, and a small correlation value means that the influence of speckle noise is large.

The correlator 62 can calculate multiple correlation values by changing a combination of two evaluation distance images. Specifically, the correlator 62 can calculate, for each evaluation region, the first correlation value r1 between the first evaluation distance image and the second evaluation distance image, the second correlation value r2 between the first evaluation distance image and the third evaluation distance image, the third correlation value r3 between the first evaluation distance image and the fourth evaluation distance image, the fourth correlation value r4 between the second evaluation distance image and the third evaluation distance image, the fifth correlation value r5 between the second evaluation distance image and the fourth evaluation distance image, and the sixth correlation value r6 between the third evaluation distance image and the fourth evaluation distance image. The number of types of correlation values calculated by the correlator 62 depends on the number of types of evaluation distance images obtained by switching of the evaluation pattern by the light source control unit 16. In the case of m types of evaluation distance images, the number of types of correlation values is m×(m−1)/2. When there are two types of evaluation distance images, for example, only one type of correlation value, which is the correlation value between the two images, can be obtained.

The smoothing intensity determination unit 64 determines the intensity of the smoothing process to be applied to the normal distance image, based on the correlation value calculated by the correlator 62. The smoothing intensity determination unit 64 may, for example, calculate an index value indicating the influence of speckle noise in the evaluation region, based on multiple correlation values r1-r6 calculated for each evaluation region, and may calculate the intensity of the smoothing process based on the index value. For example, the smoothing intensity determination unit 64 may use the average value of two or more of the multiple correlation values r1-r6 as the index value of the evaluation region. Specifically, the smoothing intensity determination unit 64 uses the average (r_ave) of three correlation values, among the six correlation values (r1-r6), with the smallest absolute values as the index value (index). The larger the index value, the smaller the influence of speckle noise in the evaluation region indicated by the index value, and the smaller the index value, the greater the influence of speckle noise in the evaluation region.

The smoothing intensity determination unit 64 may calculate the index value of each pixel based on the index value of each evaluation region. The smoothing intensity determination unit 64 may calculate the index value of a pixel in the first overlapping region 92 and the second overlapping region 94 where two or more evaluation regions overlap (see FIG. 6), based on the index value of each of the two or more evaluation regions.

For example, the smoothing intensity determination unit 64 may, for example, calculate the index value (indexmix[X,Y]) of the pixels arranged from left to right in the first overlapping region 92 of FIG. 6, where the evaluation region 80 at the center (BlockNo[x,y]) and the evaluation region 83 to the right (BlockNo[x+1,y]) overlap, based on the index value (index[x,y]) of the evaluation region 80 at the center and the index value (index[x+1,y]) of the evaluation region 83 to the right according to expression (4) below.

$$indexmix [ 1 , Y ] = index [ x , y ] \times 15 + index [ x + 1 , y ] \times 1 \qquad ( 4 )$$

$$indexmix [ 2 , Y ] = index [ x , y ] \times 14 + index [ x + 1 , y ] \times 2$$

$$indexmix [ 3 , Y ] = index [ x , y ] \times 13 + index [ x + 1 , y ] \times 3$$

$$⋯$$

$$indexmix [ 16 , Y ] = index [ x , y ] \times 0 + index [ x + 1 , y ] \times 16$$

This allows the correlation values of the pixels in the first overlapping region 92 to gradually approach the index value of the evaluation region, of the two evaluation regions, that is closer.

The smoothing intensity determination unit 64 may calculate the index value of the second overlapping region 94, based on the correlation values of the four evaluation regions overlapping in the second overlapping region 94. Further, the index value of the evaluation region 80 (BlockNo[x,y]) can be used as it is in the non-overlapping region 90, in the evaluation region 80 (BlockNo[x,y]), that does not overlap other evaluation regions.

For example, the smoothing intensity determination unit 64 multiplies the index value (index or indexmix) calculated for each region or for each pixel by GAIN to obtain an adjusted mixing gain for smoothing (mixgain) as shown in expression (5) below.

$$mixgain = indexmix \times GAIN \qquad ( 5 )$$

$$IF mixgain > 1$$

$$mixgain = 1$$

where GAIN is an arbitrary value and is, for example, 2. In the following description, the result of subtracting the mixing gain for smoothing (mixgain) from 1 is also referred to as a smoothing intensity α. Therefore, the smoothing intensity α=1-mixgain.

Referring back to FIG. 5, the smoothing processing unit 66 generates a corrected distance image by applying the smoothing process of the intensity determined by the smoothing intensity determination unit 64, i.e., the intensity determined by the correlation value, to the normal distance image generated at the time of irradiation with the normal pattern. The smoothing processing unit 66 can apply the smoothing process by, for example, using a spatial low-pass filter. The smaller the correlation value of the evaluation region of the normal distance image, the higher the intensity of the smoothing process applied by the smoothing processing unit 66 to the evaluation region. When the correlation value is small, the influence of speckle noise is large so that the image can be corrected to make the speckle noise less noticeable by increasing the intensity of the smoothing process. When the correlation value is large, on the other hand, the influence of speckle noise is small so that the uneven shape on the surface is prevented from being lost due to the smoothing process by reducing the intensity of the smoothing process. For pixels for which two or more of multiple evaluation regions overlap, the smoothing processing unit 66 may apply the smoothing process of the intensity based on the correlation value of each of the two or more regions.

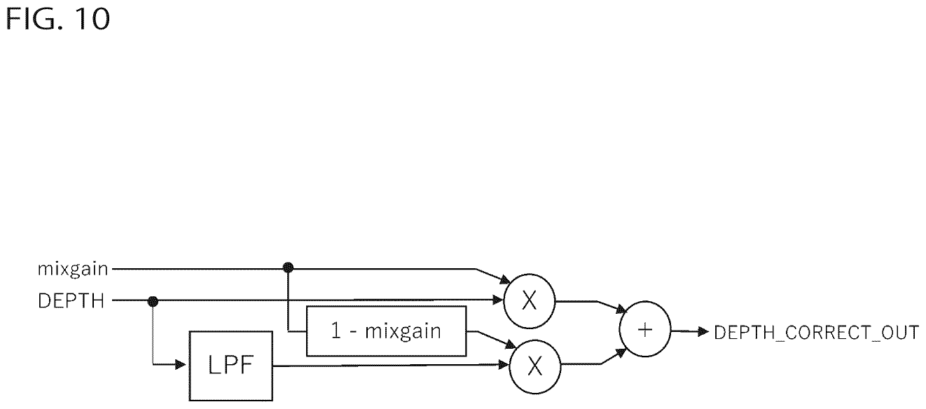

FIG. 10 is a conceptual diagram showing an exemplary flow of the smoothing process. As shown in FIG. 10, the smoothing processing unit 66 performs addition on the pixel value (DEPTH) of the pixel to be processed, by changing the ratio of mixing with the output of the LPF (low-pass filter) in accordance with the smoothing intensity (α=1-mixgain). The smoothing processing unit 66 multiplies the value derived from applying LPF to the pixel value (DEPTH) by the smoothing intensity (α=1−mixgain). The smoothing processing unit 66 multiplies the pixel value (DEPTH) to which LPF is not applied by the mixing gain for smoothing (mixgain). The smoothing processing unit 66 adds the two multiplication results above to obtain the pixel value (DEPTH_CORRECT_OUT) of the corrected distance image.

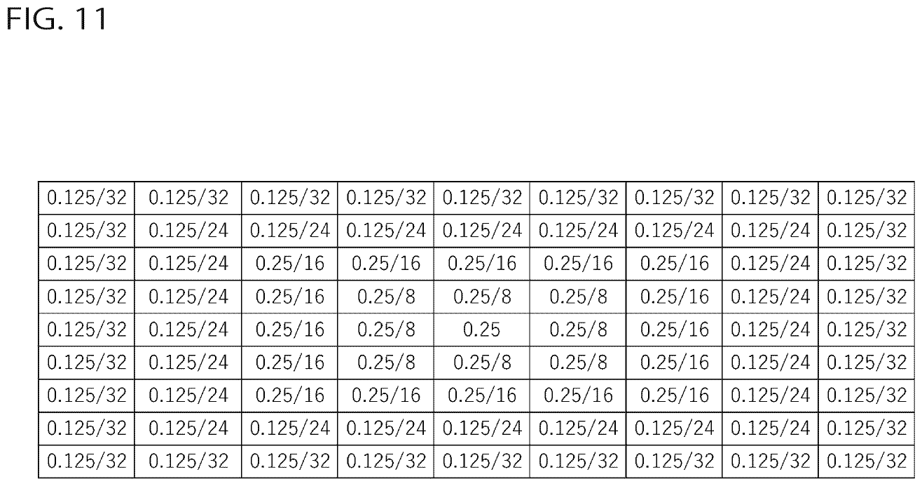

FIG. 11 shows exemplary coefficients of the low-pass filter used for the smoothing process and shows a specific example of the LPF of FIG. 10. In the example in FIG. 11, the pixel values to which LPF is applied are calculated by subjecting the pixel values in a 9 pixel×9 pixel range to weighted averaging with the LPF coefficient. The LPF coefficients are not limited to those shown in FIG. 11. The range with the number of pixels different from 9 pixels×9 pixels may be set, or coefficients different from the specific values as shown may be set.

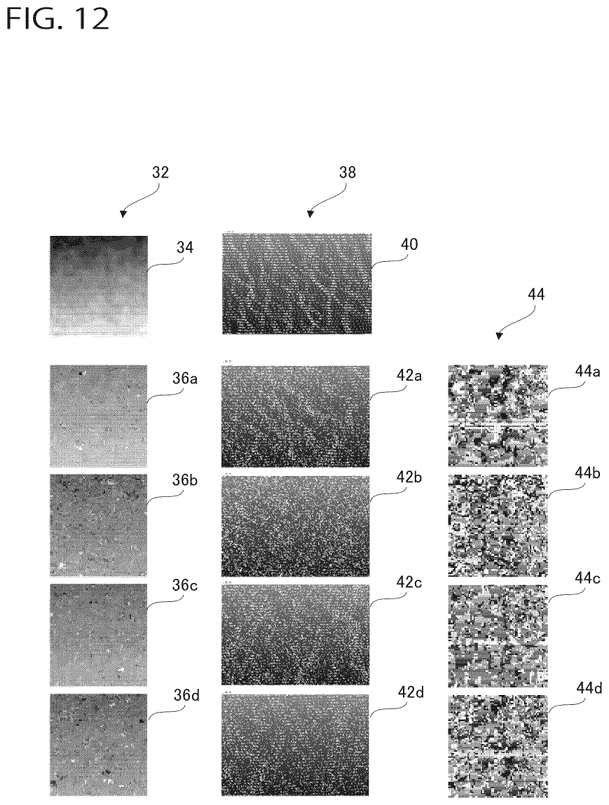

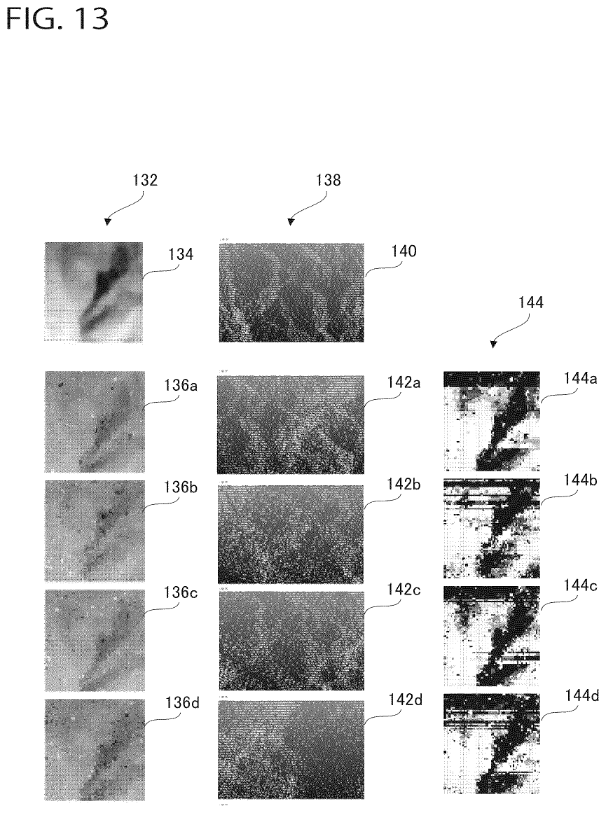

A description will now be given of an exemplary embodiment related to two subjects with different surface shapes. FIG. 12 shows a distance image 32, a point cloud image 38, and a difference value image 44 according to the first exemplary embodiment. The subject according to the first exemplary embodiment is a box made of aluminum with a flat surface. FIG. 13 shows a distance image 132, a point cloud image 138, and a difference value image 144 according to the second exemplary embodiment. The subject according to the second exemplary embodiment is wrinkled paper pasted on the surface of an aluminum box. The distance images 32, 134 and the difference value images 44,144 are images of a single evaluation region and, in this case, a region comprised of 64 pixels in width×64 pixels in height.

The point cloud images 38, 138 are three-dimensional images obtained from point cloud data obtained by mapping the pixel value (DEPTH) of each pixel in the distance images 32,132 to a three-dimensional space. The difference value images 44,144 are images comprised of difference values (DEPTH) calculated by the inclination removal unit 60. The distance images 32, 132 and the difference value images 44, 144 are shown such that the larger the pixel value, the darker the color (closer to black), and the smaller the pixel value, the thinner the color (closer to white).

FIG. 12 shows the distance image 32 by showing a normal distance image 34, a first evaluation distance image 36a, a second evaluation distance image 36b, a third evaluation distance image 36c, and a fourth evaluation distance image 36d. The figure shows the point cloud image 38 by showing a normal point cloud image 40 obtained from the normal distance image 34, a first point cloud image 42a obtained from the first evaluation distance image 36a, a second point cloud image 42b obtained from the second evaluation distance image 36b, a third point cloud image 42c obtained from the third evaluation distance image 36c, and a fourth point cloud image 42d obtained from the fourth evaluation distance image 36d. The figure shows the difference value image 44 by showing a first difference value image 44a obtained from the first evaluation distance image 36a, a second difference value image 44b obtained from the second evaluation distance image 36b, a third difference value image 44c obtained from the third evaluation distance image 36c, and a fourth difference value image 44d obtained from the fourth evaluation distance image 36d. The same applies to the normal distance image 134, first evaluation distance image 136a-fourth evaluation distance image 136d, a normal point cloud image 140, first point cloud image 142a-fourth point cloud image 142d, and first difference value image 144a-fourth difference value image 144d shown in FIG. 13.

First, the normal point cloud image 40 is compared with the normal point cloud image 140. The normal point cloud image 40 obtained from a subject with a flat surface includes a wavy pattern. Meanwhile, the normal point cloud image 140 obtained from a subject with wrinkles on the surface also includes a wavy pattern. Therefore, it is difficult to determine whether this pattern is caused by the wrinkles (uneven shape) of the subject or by the speckle noise merely by referring to the normal point cloud images 40, 140 generated from the distance image obtained by lighting with the normal pattern.

The first difference value image 44a-the fourth difference value image 44d are then compared with the first difference value image 144a-the fourth difference value image 144d. A correlation cannot be visually identified in the first difference value image 44a-the fourth difference value image 44d obtained from a subject with a flat surface. On the other hand, a pattern of a similar shape can be visually identified and a correlation is considered to be high by referring to the first difference value image 144a-the fourth difference value image 144d obtained from a subject with wrinkles on the surface.

The correlation values (r1-r6) between the first evaluation distance image 36a-the fourth evaluation distance image 36d in FIG. 11 are such that r1=0.094798, r2=0.20169, r3=0.151683, r4=0.084219, r5=0.063144, r6=0.113293, and the average value (r_ave) of the three correlation values (r1, r4, r5) with the smallest absolute values is 0.08072. On the other hand, the correlation values (r1-r6) between the first evaluation distance image 136a-the fourth evaluation distance image 136d in FIG. 12 are such that r1=0.449943, r2=0.781383, r3=0.747637, r4=0.404592, r5=0.370536, r6=0.681427, and the average value (r_ave) of the three correlation values (r1, r4, r5) with smallest absolute values is 0.408357. Thus, the correlation value of the evaluation region obtained in a subject with a flat surface is smaller than the correlation value obtained in a subject with a wrinkled surface. Given the uneven shape on the surface of the subject and the speckle noise, it is confirmed, based on the foregoing, that the correlation value is low in a region where the speckle noise is dominant, and the correlation value is high in a region where the uneven shape on the surface of the subject is dominant.

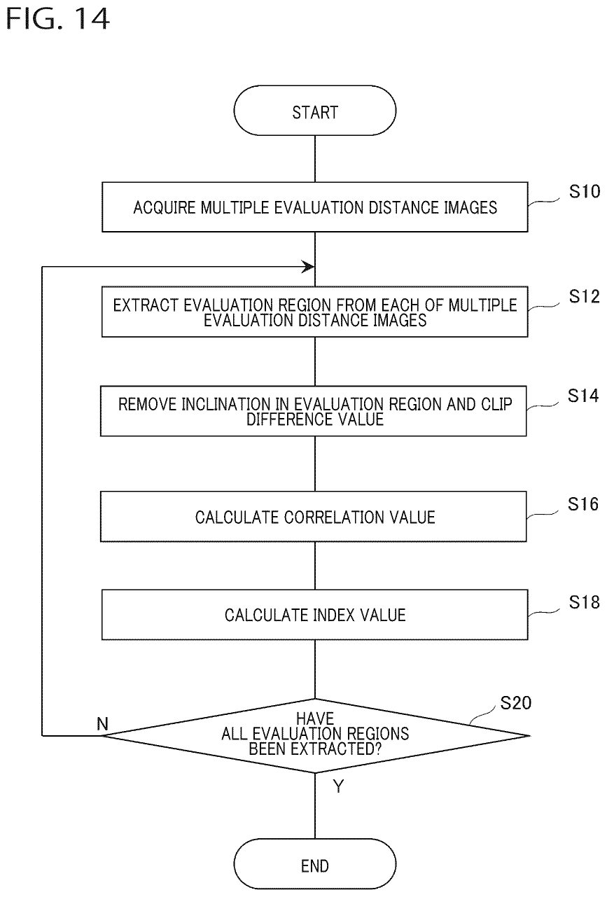

FIG. 14 is a flow chart showing a process of calculating the index value according to the first embodiment. The image acquisition unit 52 acquires multiple evaluation distance images (S10). The multiple evaluation distance images are the first-fourth evaluation distance image generated by the distance sensor block 14 by switching between the first-fourth evaluation patterns by the light source control unit 16. Alternatively, each of the multiple evaluation distance images may be derived from subjecting the pixel values of multiple frames of the distance image to moving averaging in the temporal direction by the moving averaging unit 54.

The evaluation region extraction unit 56 extracts the evaluation region from each of the multiple evaluation distance images (S12). The inclination removal unit 60 uses the inclination component value calculated by the inclination calculation unit 58 to calculate the difference value of each pixel by removing the inclination in the evaluation region and to clip the difference value by the upper and lower values (S14).

The correlator 62 calculates, for the evaluation region extracted in step S12, the correlation value between two of the multiple evaluation distance images (S16). The smoothing intensity determination unit 64 calculates the index value of the evaluation region extracted in step S12, based on multiple correlation values calculated in step S16 (S18). When the evaluation region extraction unit 56 has not extracted all evaluation regions (N in S20), control returns to the process of step S12. When the evaluation region extraction unit 56 has extracted all evaluation regions (Y in S20), the process is terminated.

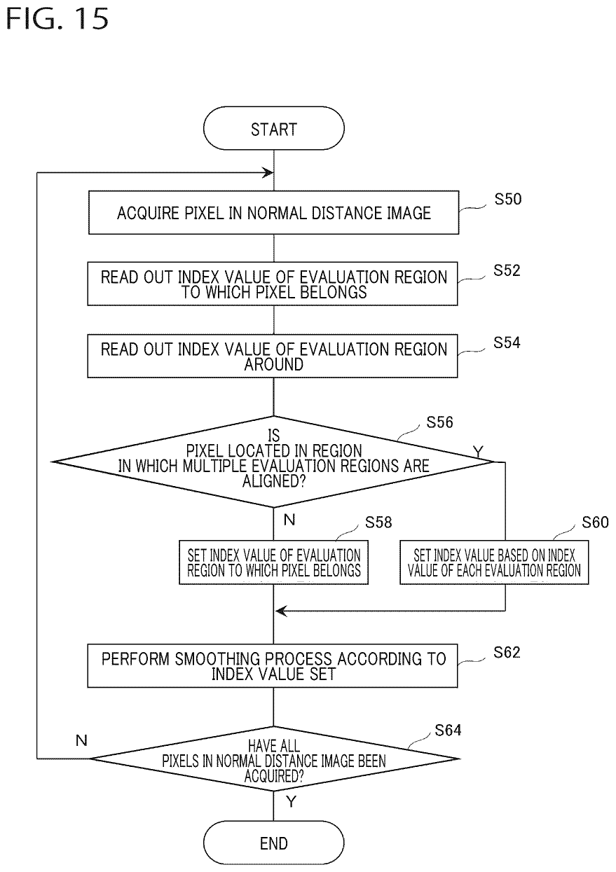

FIG. 15 is a flowchart showing a process of correcting the normal distance image according to the first embodiment. The smoothing intensity determination unit 64 acquires a pixel in the normal distance image acquired by the image acquisition unit 52 (S50). The smoothing intensity determination unit 64 reads out the index value of the evaluation region to which the acquired pixel belongs (S52). The index value calculated by the index value calculation process shown in FIG. 15 can be used as the index value of the evaluation region. The smoothing intensity determination unit 64 reads out the index value of the evaluation region around the evaluation region to which the acquired pixel belongs (S54). When the acquired pixel is not located in a region in which multiple evaluation regions overlap, i.e., when the acquired pixel belongs to only one evaluation region (N in S56), the smoothing intensity determination unit 64 sets the index value of the evaluation region to which the pixel belongs to be the index value of the pixel (S58). When the acquired pixel is located in a region where multiple evaluation regions overlap (Y in S56), on the other hand, the smoothing intensity determination unit 64 sets the index value based on the index value of each evaluation region to be the index value of that pixel (S60). After the process in step S58 and step S60, the smoothing processing unit 66 performs the smoothing process on the pixel according to the index value thus set (S62). When the smoothing intensity determination unit 64 has not acquired all pixels in the normal distance image (N in S64), control returns to the process of step S50. When the smoothing intensity determination unit 64 has acquired all pixels in the normal distance image (Y in S64), on the other hand, the process is terminated.

According to this embodiment, the correlation value between the first evaluation distance image obtained by irradiating the subject 20 from the first light source 12a and the second evaluation distance image obtained by irradiating the subject 20 from the second light source 12b is calculated for each of the multiple evaluation regions. Further, the smoothing process of the intensity determined by the correlation value is applied to the normal distance image obtained by irradiating the subject 20 from the first light source 12a and the second light source 12b. Therefore, the speckle noise can be reduced by configuring the smoothing process in the evaluation region with a low correlation value to be relatively intense, and the uneven shape of the subject 20 can be reproduced in the normal distance image by configuring the smoothing process in the evaluation region with a high correlation value to be relatively weak.

According to this embodiment, the inclination component value of each pixel in the first evaluation distance image and the second evaluation distance image is calculated based on the average value of the pixel values of multiple pixels arranged vertically or horizontally in each region of the multiple evaluation regions. Further, the correlation value is calculated by using the difference value derived from subtracting the inclination component value from the pixel value of each pixel in the first evaluation distance image and the second evaluation distance image. When the subject 20 is inclined in the depth direction, the correlation value tends to be high due to the inclination, and so it is difficult to evaluate the influence of speckle noise. By calculating the correlation value by using the difference value derived from subtracting the inclination component value from the pixel value of each pixel, the influence of this inclination can be reduced and the correlation value that indicates the influence of speckle noise can be calculated more properly.

According to this embodiment, when the difference value is greater than a predetermined upper limit value, the upper limit value is used to calculate the correlation value, and, when the difference value is smaller than a predetermined lower limit value, the lower limit value is used to calculate the correlation value. Therefore, the influence of outliers such as flying pixels can be reduced so that the correlation value that indicates the influence of speckle noise can be calculated more properly.

According to this embodiment, the multiple evaluation regions are set to overlap partially, and, for pixels for which two or more of the multiple evaluation regions overlap, the smoothing process of the intensity based on the correlation value of each of the two or more regions is applied. Therefore, the intensity of the smoothing process applied to continuous pixels can be configured to change gradually so that the corrected distance image obtained by applying the smoothing process can be made to appear more natural.

### Second Embodiment

The first embodiment assumes that the subject is not moving. The second embodiment will be described below as an embodiment adapted to the case where the subject is moving.

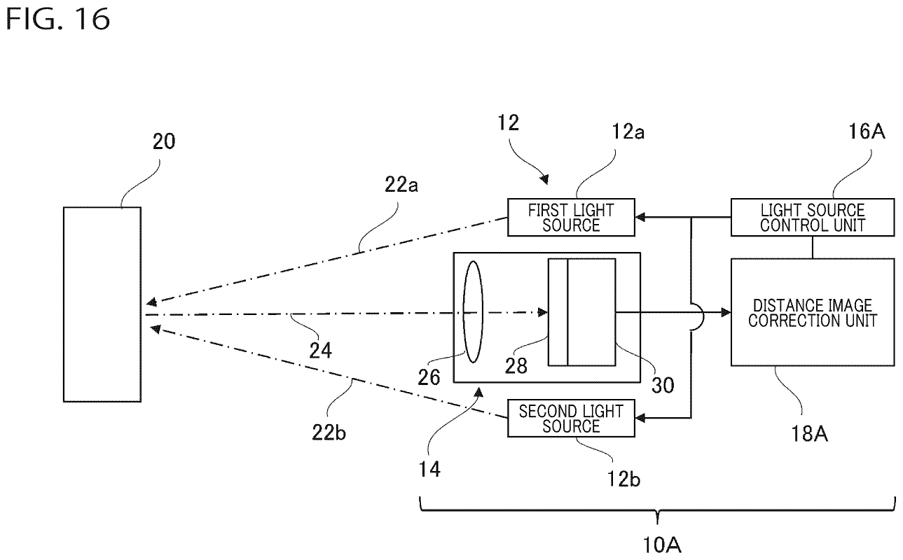

FIG. 16 schematically shows a configuration of a ranging apparatus 10A according to the second embodiment. In the second embodiment, a light source control unit 16A and a distance image correction unit 18A differ from those of the first embodiment. The following description of the second embodiment highlights the difference from the first embodiment. A description of common features is omitted as appropriate. In the figures, those features that are equivalent to the features of the first embodiment are denoted by the same reference numerals.

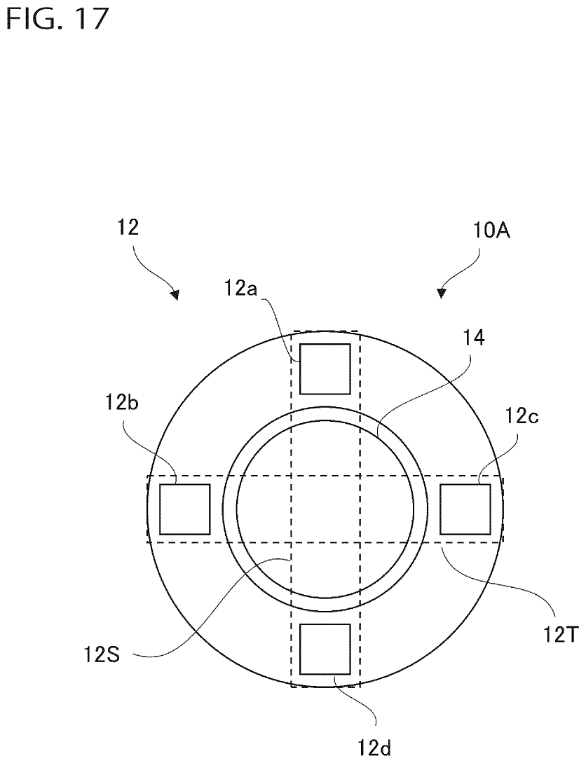

FIG. 17 is a schematic diagram showing a configuration of the light source apparatus 12. FIG. 17 shows the ranging apparatus 10A viewed from the side of the subject 20. The evaluation pattern switched by the light source control unit 16A is different from that of the first embodiment and includes the first evaluation pattern in which a first light source group 12S is turned on and the second evaluation pattern in which a second light source group 12T is turned on. The first light source group 12S includes the first light source 12a and the fourth light source 12d. Further, the second light source group 12T includes the second light source 12b and the third light source 12c. In other words, the first evaluation pattern is a pattern in which the first light source 12a and the fourth light source 12d are turned on at the same time. The second evaluation pattern is a pattern in which the second light source 12b and the third light source 12c are turned on at the same time.

Referring back to FIG. 16, the light source control unit 16A switches between the normal pattern, the first evaluation pattern, and the second evaluation pattern in a predetermined order. The light source control unit 16A may repeatedly switch the lighting pattern in a predetermined order. The predetermined order denotes, for example, switching in the order of the first evaluation pattern, the normal pattern, the second evaluation pattern, and the normal pattern. The light source control unit 16A switches the lighting pattern at, for example, 20 frames per second, which is a non-limiting feature.

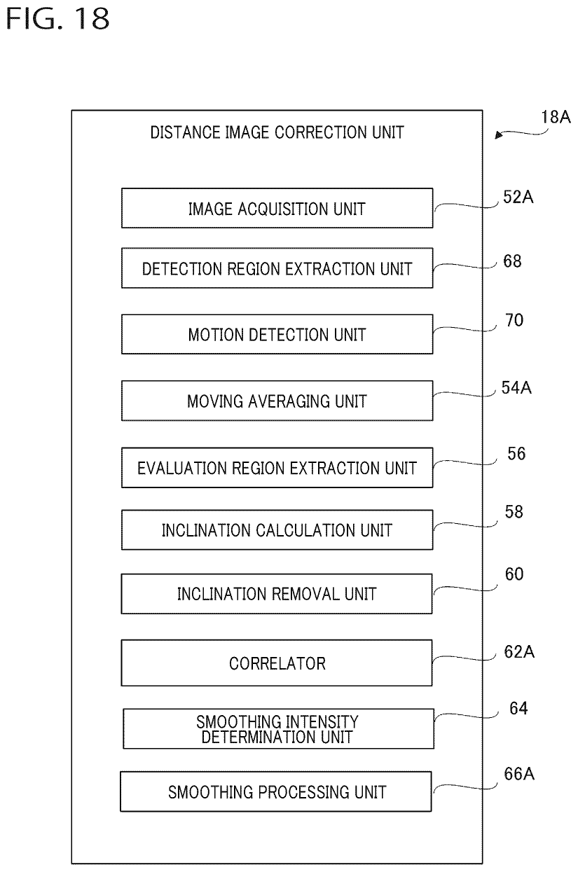

FIG. 18 is a block diagram schematically showing a functional configuration of the distance image correction unit 18A. The distance image correction unit 18A differs from the distance image correction unit 18 of the first embodiment in respect of an image acquisition unit 52A, a moving averaging unit 54A, a correlator 62A, and a smoothing processing unit 66A. Further, the distance image correction unit 18A differs from the distance image correction unit 18 of the first embodiment in that a detection region extraction unit 68 and a motion detection unit 70 are further provided.

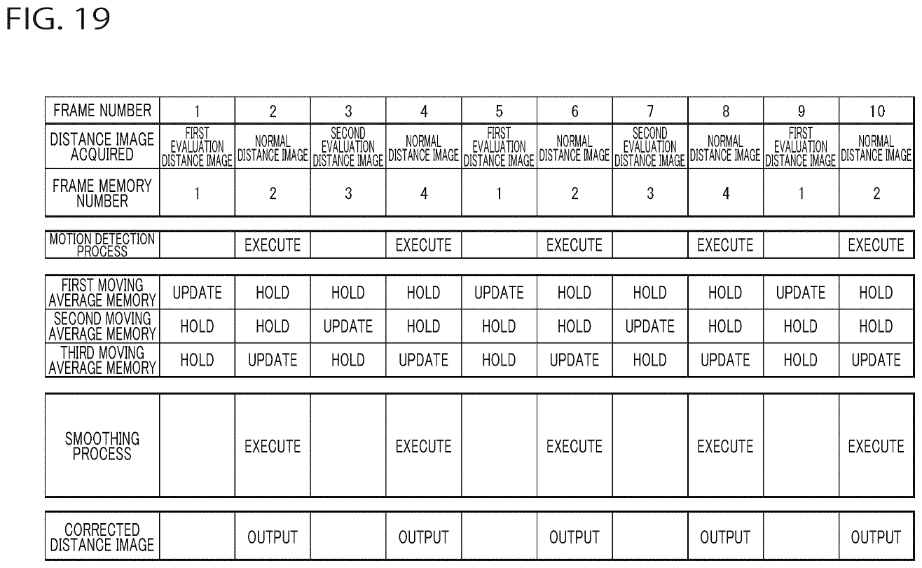

The image acquisition unit 52A sequentially acquires the distance image corresponding to each lighting pattern according to the switching of the lighting pattern in a predetermined order performed by the light source control unit 16A. FIG. 19 shows an exemplary operation of the distance image correction unit 18A in units of frames. For example, the image acquisition unit 52A acquires the first evaluation distance image in the first frame and stores it in the first frame memory. The image acquisition unit 52A acquires the normal distance image in the second frame and stores it in the second frame memory. The image acquisition unit 52A acquires the second evaluation distance image in the third frame and stores it in the third frame memory. The image acquisition unit 52A acquires the normal distance image in the fourth frame and stores it in the fourth frame memory. The image acquisition unit 52A repeats the operation in the first-fourth frames similarly in the fifth-eighth frames and the ninth-twelfth frame, repeating the same steps subsequently.

Referring back to FIG. 18, the detection region extraction unit 68 extracts, from the distance image, a detection region for use in a motion detection process by the motion detection unit 70. The detection region can be a preset region. The detection region can be arbitrarily set according to the range of motion of the subject to be detected and is, for example, a region comprised of 16 pixels in width×16 pixels in height. The detection region extraction unit 68 may extract the detection region in every frame of the distance image acquired by the image acquisition unit 52A.

The motion detection unit 70 compares multiple normal distance images generated at different points of time and detects a motion in each of the multiple detection regions set in the normal distance image. In the example shown in FIG. 19, the motion detection unit 70 calculates a correlation value (hereinafter referred to as the “motion correlation value”) for each detection region between the normal distance image stored in the second frame memory and the normal distance image stored in the fourth frame memory, which images are stored at points of time when the frame has an even number. When the absolute value of the motion correlation value thus calculated is equal to or lower than a predetermined threshold, the motion detection unit 70 sets the motion flag of the detection region to 1. This is because a low absolute value of the motion correlation value between multiple normal distance images generated at different points of times is considered to be caused by the motion of the subject. The motion correlation value can, for example, be calculated by using expression (3) above. Specifically, the motion correlation value can be calculated by substituting the pixel value of the detection region in the second frame memory into x and substituting the pixel value of the same pixel in the fourth frame memory into y in expression (3), where n denotes the number of pixels in the detection region.

The moving averaging unit 54A calculates the moving average of the pixel values of the multiple distance images generated at different points of time. The multiple distance images used here are multiple distance images generated when the light source control unit 16A uses the same lighting pattern. In other words, all of the multiple distance images are either first distance images, second distance images, or normal distance images. Further, the moving averaging unit 54A changes the level of moving averaging depending on whether the motion detection unit 70 detects a motion. To be specific, the moving averaging unit 54A does not perform moving averaging for pixels in the region, of the multiple detection regions, where a motion is detected, and, for pixels in the region where a motion is not detected, performs moving averaging of pixel values of multiple distance images generated at multiple points of time.

Weighted averaging by the moving averaging unit 54A may be of FIR (Finite Impulse Response) type of cyclic type. In the case of the point of time of the fifth frame of FIG. 19, for example, the moving averaging unit 54A of cyclic type multiplies the pixel value (IN) of the pixel in the first evaluation distance image newly acquired and stored in the first frame memory by a coefficient (1/A). Further, the moving averaging unit 54A multiplies the pixel value (1FB) of the pixel in the first evaluation distance image stored in the first moving average memory by a coefficient (1−1/A). By adding the multiplication results, the weighted average (MOVEAVE) of the pixel values of the first evaluation distance image is calculated. The calculation is given by expression (6) below.

$$MOVEAVE = 1 / A \times IN + ( 1 - 1 / A ) \times 1 FB \qquad ( 6 )$$

where, 1FB denotes the pixel value of the pixel in the first frame of the first evaluation distance image. A can be changed as desired.

The moving averaging unit 54A stores MOVEAVE calculated according to expression (6) in the first moving average memory. Then, at the point of time of the ninth frame, next MOVEAVE is calculated by reading 1FB of expression (6) from the first moving average memory. In this way, the weighted average of the pixel values of the first evaluation distance image is updated as needed.

When the moving averaging unit 54A calculates the weighted average of the pixel values of the first evaluation distance image, and when the motion flag of the detection region including the pixels is set to 1, coefficient (A) of expression (6) is set to 1. For example, when the moving averaging unit 54A calculates the weighted average of the fifth frame, and when the motion flag is set to 1 in the second or fourth frame, the calculated weighted average will be equal to the pixel value of the first evaluation distance image acquired in the fifth frame, by setting coefficient (A) of expression (6) to 1. In other words, the cycle of weighted averaging is reset.

The moving averaging unit 54A calculates, similarly as above, the weighted average of the pixel values of the pixels in the second evaluation distance image at the points of time when the third frame, the seventh frame, the eleventh frame, . . . of the second evaluation distance image are acquired and stores the calculated values in the second moving average memory. The moving averaging unit 54A similarly calculates the weighted average of the pixel values of the pixels in the normal distance image at the points of time when the second frame, the fourth frame, the sixth frame, . . . of the normal distance image are acquired and stores the calculated values in the third moving average memory. Also similarly as above, coefficient (A) of expression (6) is set to 1 when the motion flag is set to 1.

As described above, the random noise in the distance image can be reduced by using the moving averaging unit 54A to subject the pixel values of multiple distance images generated by at multiple points of time to weighted averaging. Further, the moving averaging unit 54A does not subject the pixel values of the pixels in the region where a motion is detected to weighted averaging so that it is possible to eliminate the influence from adding distance images that are generated before and after the detection of the motion and that differ in the state of the subject.

The evaluation region extraction unit 56, the inclination calculation unit 58, and the inclination removal unit 60 are similar to those of the first embodiment. In this embodiment, however, the inclination removal unit 60 calculates the difference value of the pixel of each evaluation distance image by using the result of calculation of the weighted average by the moving averaging unit 54A. In the example of FIG. 19, the inclination removal unit 60 reads out the pixel value of each pixel in the first evaluation distance image from the first moving average memory and calculates the difference value. Further, the inclination removal unit 60 reads out the pixel value of each pixel in the second evaluation distance image from the second moving average memory and calculates the difference value.

The correlator 62A, like the correlator 62 of the first embodiment, calculates the correlation value between the first evaluation distance image and the second evaluation distance image for each evaluation region. However, since there are no evaluation distance images other than the first evaluation distance image and the second evaluation distance image in this embodiment, only the correlation value between the first evaluation distance image and the second evaluation distance image needs to be calculated.

With regard to the pixels in the region, of the multiple detection regions, where a motion is detected, the correlator 62A calculates the correlation value from the pixel values of the distance image generated at the point of time corresponding to the detection of the motion. Further, with regard to the pixels in the region, of the multiple detection regions where a motion is not detected, the correlator 62A calculates the correlation value from the weighted average of the pixel values of the multiple distance images generated at multiple points of time.

In the example shown in FIG. 19, the correlator 62A reads out the pixel value of each pixel in the first evaluation distance image from the first moving average memory and reads out the pixel value of each pixel in the second evaluation distance image from the second moving average memory to calculate the correlation value. The correlator 62A may calculate the correlation value by using the difference value calculated by the inclination removal unit 60. In other words, the correlator 62A may calculate the correlation value by using the difference value derived from subtracting the inclination component value from the pixel value of each pixel in the first evaluation distance image and the second evaluation distance image. Alternatively, the correlator 62A may, when the difference value is greater than a predetermined upper limit value, use the upper limit value to calculate the correlation value and may, when the difference value is smaller than a predetermined lower limit value, use the lower limit value to calculate the correlation value.

The correlator 62A may calculate the correlation value when a new distance image is acquired. For example, the correlator 62A may calculate the correlation value at the point of time of the even-numbered frame when the normal distance image is acquired.

The smoothing processing unit 66A, like the smoothing processing unit 66 of the first embodiment, generates a corrected distance image by applying the smoothing process of the intensity determined by the correlation value to the normal distance image generated at the time of irradiation with the normal pattern. The normal distance image to which the smoothing processing unit 66A applies the smoothing process may be the normal distance image subjected to weighted averaging stored in the second moving average memory of FIG. 19. The smoothing processing unit 66A applies the smoothing process to the detection region where a motion is not detected to generate a corrected distance image. Meanwhile, the smoothing processing unit 66A does not apply the smoothing process to the detection region where a motion is detected. For example, the smoothing processing unit 66A sets the mixing gain for smoothing (mixgain) of FIG. 10 to 1 in the detection region where the motion flag is set to 1. In other words, the smoothing process may be skipped by setting the smoothing intensity α to 0. The smoothing processing unit 66A may generate a corrected distance image at the point of time of an even-numbered frame when the normal distance image is acquired.

The ranging apparatus 10A may output the corrected distance image thus generated as needed. The ranging apparatus 10A may output the corrected distance image each time the corrected distance image is generated at the point of time of an even-numbered frame. This enables real-time acquisition of the corrected distance images with reduced speckle noise.

According to this embodiment, the smoothing process is applied to the detection region, of the multiple detection regions set in the normal distance image, where a motion is not detected. Therefore, the smoothing process can be selectively applied to the region where the speckle noise on the surface of the subject is noticeable due to the lack of motion of the subject.

According to this embodiment, the correlation value of the pixels in the region, of the multiple detection regions, where a motion is not detected is calculated from the weighted average of the pixel values of the multiple distance images generated at multiple points of time. Therefore, the random noise can be removed by the weighted averaging process and the correlation value indicating the influence of speckle noise can be calculated more properly, in the region where the speckle noise is noticeable due to the lack of motion of the subject.

The present disclosure has been explained with reference to the embodiments described above, but the present disclosure is not limited to the embodiments described above, and appropriate combinations or replacements of the features presented in the embodiments are also encompassed by the present disclosure.

What is claimed is:

1. A ranging apparatus comprising:
a first light source that irradiates a subject with a first illumination light;
a second light source that irradiates the subject with a second illumination light;
a distance sensor that detects a light from the subject and generates a distance image;
a light source control unit that switches between a normal pattern of lighting the first light source and the second light source, a first evaluation pattern of lighting the first light source, and a second evaluation pattern of lighting the second light source;
a correlator that calculates, for each of a plurality of evaluation regions set in the distance image, a correlation value between a first evaluation distance image generated at a time of irradiation with the first evaluation pattern and a second evaluation distance image generated at a time of irradiation with the second evaluation pattern; and
a smoothing processing unit that generates a corrected distance image by applying a smoothing process of an intensity determined by the correlation value to a normal distance image generated at a time of irradiation with the normal pattern.

2. The ranging apparatus according to claim 1, further comprising:
an inclination calculation unit that refers to the first evaluation distance image and the second evaluation distance image and calculates an inclination component value based on an average value of a plurality of pixels arranged vertically or horizontally in each region of the plurality of evaluation regions,
wherein the correlator calculates the correlation value by using a difference value derived from subtracting the inclination component value from a pixel value of each pixel in the first evaluation distance image and the second evaluation distance image.

3. The ranging apparatus according to claim 2,
wherein the correlator uses, when the difference value is greater than a predetermined upper limit value, the upper limit value to calculate the correlation value and uses, when the difference value is smaller than a predetermined lower limit value, the lower limit value to calculate the correlation value.

4. The ranging apparatus according to claim 1,
wherein the plurality of evaluation regions are set so as to overlap partially, and
wherein the smoothing processing unit applies, to pixels for which two or more of the plurality of evaluation regions overlap, the smoothing process of an intensity based on the correlation value of each of the two or more regions.

5. The ranging apparatus according to claim 1, further comprising:
a motion detection unit that compares a plurality of normal distance images generated at different points of time and detects a motion in each of a plurality of detection regions set in the normal distance image,
wherein the smoothing processing unit applies the smoothing process to the detection region where a motion is not detected to generate the corrected distance image.

6. The ranging apparatus according to claim 5,
wherein the correlator:
calculates the correlation value of a pixel in a region, of the plurality of detection regions, where a motion is detected from pixel values of the first evaluation distance image and the second evaluation distance image generated at a point of time corresponding to detection of the motion, and
calculates the correlation value of a pixel in a region, of the plurality of detection regions, where a motion is not detected from a weighted average of pixel values of a plurality of first evaluation distance images generated at a plurality of points of time and a weighted average of pixel values of a plurality of second evaluation distance images generated at a plurality of points of time.

7. A ranging method comprising:
switching between a normal pattern of lighting a first light source that irradiates a subject with a first illumination light and a second light source that irradiates the subject with a second illumination light, a first evaluation pattern of lighting the first light source, and a second evaluation pattern of lighting the second light source;
detecting a light from the subject by using a distance sensor and generating a distance image;
calculating, for each of a plurality of evaluation regions set in the distance image, a correlation value between a first evaluation distance image generated at a time of irradiation with the first evaluation pattern and a second evaluation distance image generated at a time of irradiation with the second evaluation pattern; and
generating a corrected distance image by applying a smoothing process of an intensity determined by the correlation value to a normal distance image generated at a time of irradiation with the normal pattern.
